(19) United States
(12) Patent Application Publication
(10) Pub. No.: US 2011/0146870 A1
(43) Pub. Date: Jun. 23, 2011

(54) TIRE WITH INNERLINER CONTAINING SLATE POWDER

(76) Inventors: Carolin Anna Welter, Sandhausen (DE); Thomas Hermann Mans, Poppenhausen (DE); Claude Schweitzer, Colmar-Berg (LU)

(21) Appl. No.: 12/640,032

(22) Filed: Dec. 17, 2009

(51) Int. Cl. B60C 5/14

(52) U.S. Cl. 152/510

(57) ABSTRACT

The present invention is directed to a pneumatic tire comprising a carcass and an innerliner radially inward of and in direct contact with the carcass, the innerliner comprising a rubber composition comprising:
100 parts by weight of at least one elastomer; and
from 10 to 80 parts by weight, per 100 parts by weight of elastomer (phr) of carbon black; and
from 1 to 30 phr of slate powder.

### BACKGROUND OF THE INVENTION

A pneumatic rubber tire is conventionally of a toroidal shape and comprised of a carcass with a cavity in which its closure is typically completed with a rigid rim onto which the tire is to be mounted. Such pneumatic tire and pneumatic tire/rim assembly is well known.

The inner surface of a pneumatic tire, namely a surface of said cavity which is sometimes referred to as an “innerliner” is typically a rubber layer composed of an elastomeric composition designed to prevent, or retard, the permeation of air and moisture into the tire carcass from the aforesaid cavity which becomes the tire's inner air chamber. Such tire innerliners, or innerliner rubber layers, are well known to those having skill in such art.

Butyl rubber is typically relatively impermeable to air and moisture and is often used as a major portion of the tire innerliner composition and can be in a form of butyl rubber or halobutyl rubber such as, for example, bromobutyl rubber. For example, see U.S. Pat. No. 3,808,177. Butyl rubber is an isobutylene copolymer with a small amount of isoprene which typically contains only from about 0.5 to about 5 weight percent units derived from isoprene.

Halobutyl and butyl rubbers are usually one of the most expensive elastomers used in a tire. Given the competitive tire market and the continued need to lower the cost of manufacturing tires, there exists a desire to decrease the cost of innerliners while maintaining their performance.

### SUMMARY OF THE INVENTION

The present invention is directed to a pneumatic tire comprising a carcass and an innerliner radially inward of and in direct contact with the carcass, the innerliner comprising a rubber composition comprising:

100 parts by weight of at least one elastomer; and

from 10 to 80 parts by weight, per 100 parts by weight of elastomer (phr) of carbon black; and

from 1 to 30 phr of slate powder.

### DESCRIPTION OF THE INVENTION

There is disclosed a pneumatic tire comprising a carcass and an innerliner radially inward of and in direct contact with the carcass, the innerliner comprising a rubber composition comprising:

100 parts by weight of at least one elastomer; and

from 10 to 80 parts by weight, per 100 parts by weight of elastomer (phr) of carbon black; and

from 1 to 30 phr of slate powder.

It has been found unexpectedly that an inclusion in the tire innerliner rubber composition of a slate powder, results in an innerliner having high resistance to permeability with acceptable tear strength.

In the description of the invention, the term “phr” relates to parts by weight of a particular ingredient per 100 parts by weight of rubber contained in a rubber composition. The terms “rubber” and “elastomer” are used interchangeably unless otherwise indicated, the terms “cure” and “vulcanize” may be used interchangeably unless otherwise indicated and the terms “rubber composition” and “rubber compound” may be used interchangeably unless otherwise indicated. The term “butyl type rubber” is used herein to refer to butyl rubber (copolymer of isobutylene with a minor amount comprised of, for example about 0.5 to 5 weight percent, alternatively from 1 to about 3 percent, of units derived from isoprene), and halobutyl rubber as chlorobutyl rubber and bromobutyl rubber (chlorinated and brominated butyl rubber, respectively) unless otherwise indicated.

The rubber composition for use in the innerliner of the present invention includes an elastomer. Suitable elastomers include butyl type rubber, including butyl rubber and halobutyl rubbers such as chlorobutyl rubber and bromobutyl rubber. Other suitable elastomers include synthetic polyisoprene, natural rubber, styrene butadiene rubber, and polybutadiene.

An alternative butyl rubber for the innerliner is comprised of a brominated copolymer of isobutylene and paramethylstyrene. The brominated copolymer conventionally contains from about 0.3 to about 2 weight percent bromination. Exemplary of such a brominated copolymer is Exxpro® from ExxonMobil Chemical reportedly having a Mooney (ML 1+8) viscosity at 125° C. of from about 45 to about 55, a paramethylstyrene content of about 5 weight percent, isobutylene content of about 94 to about 95 weight percent, and a bromine content of about 0.8 weight percent. Alternately, the butyl rubber may be comprised of a combination of a copolymer of isobutylene and isoprene together with a brominated copolymer of isobutylene and paramethylstyrene.

The rubber composition for use in the innerliner also includes slate powder. The slate powder has a size distribution that may be determined for example by vibrating screen analysis, and may be expressed as a cumulative size distribution. In one embodiment, the slate powder comprises at least 20 percent by weight of particles having a size less than 75 microns. In one embodiment, the slate powder comprises at least 40 percent by weight of particles having a size less than 150 microns. In one embodiment, the slate powder comprises at least 60 percent by weight of particles having a size less than 300 microns. In one embodiment, the slate powder comprises at least 80 percent by weight of particles having a size less than 850 microns. In one embodiment, the slate powder comprises at least 90 percent by weight of particles having a size less than 1700 microns. Suitable slate powder may be obtained from Theis & Boeger, Hunsrueck, Germany.

In one embodiment, the amount of slate powder may be present in the rubber composition in an amount ranging from 1 to 30 phr. In another embodiment, the amount of slate powder may be present in the rubber composition in an amount ranging from 5 to 20 phr.

In addition to the aforesaid elastomers and slate powder, for the tire innerliner, the innerliner rubber composition may also contain other conventional ingredients commonly used in rubber vulcanizates, for example, tackifier resins, processing aids, carbon black, silica, talc, clay, mica, antioxidants, antiozonants, stearic acid, activators, waxes and oils as may be desired. In one embodiment, carbon black may be used in a range of from 10 to 80 phr. In another embodiment, carbon black may be used in a range of from 20 to 60 phr.

The vulcanization of the compound for use as an innerliner is conducted in the presence of a sulfur vulcanizing agent. Examples of suitable sulfur vulcanizing agents include elemental sulfur (free sulfur) or sulfur donating vulcanizing agents, for example, an amine disulfide, polymeric disulfide or sulfur olefin adducts. Preferably, the sulfur vulcanizing agent is elemental sulfur. As known to those skilled in the art, sulfur vulcanizing agents are used in an amount ranging from about 0.2 to 5.0 phr with a range of from about 0.5 to 3.0 being preferred.

Accelerators are used to control the time and/or temperature required for vulcanization and to improve the properties of the vulcanizate. A single accelerator system may be used, i.e., primary accelerator in conventional amounts ranging from about 0.5 to 3.0 phr. In the alternative, combinations of 2 or more accelerators may be used which may consist of a primary accelerator which is generally used in the larger amount (0.3 to 3.0 phr), and a secondary accelerator which is generally used in smaller amounts (0.05 to 1.0 phr) in order to activate and to improve the properties of the vulcanizate. Combinations of these accelerators have been known to produce a synergistic effect on the final properties and are somewhat better than those produced by either accelerator alone. In addition, delayed action accelerators may be used which are not affected by normal processing temperatures but produce satisfactory cures at ordinary vulcanization temperatures. Suitable types of accelerators that may be used are amines, disulfides, guanidines, thioureas, thiazoles, thiurams, sulfenamides, dithiocarbamate and xanthates. Preferably, the primary accelerator is a disulfide or sulfenamide.

Various synthetic, amorphous silicas may be used for the tire innerliner composition. Representative of such silicas are, for example and not intended to be limiting, precipitated silicas as, for example, HiSil 210™ and HiSil 243™ from PPG Industries, as well as various precipitated silicas from J. M. Huber Company, various precipitated silicas from Degussa Company and various precipitated silicas from Rhodia Company.

Various coupling agents may be used for the various synthetic, amorphous silicas, particularly the precipitated silicas, to couple the silica aggregates to various of the elastomers. Representative of such coupling agents are, for example and not intended to be limiting, bis(3-trialkoxysilylpropyl) polysulfides wherein at least two, and optionally all three, of its alkoxy groups are ethoxy groups and its polysulfidic bridge is comprised of an average of from about 2 to about 4, alternatively from about 2 to about 2.6 or an average of from about 3.4 to about 3.8 connecting sulfur atoms, and an alkoxyorganomercaptosilane which may optionally have its mercpto moiety blocked with a suitable blocking agent during the mixing thereof with the rubber composition, wherein said alkoxy group is preferably an ethoxy group.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art.

In practice the innerliner rubber composition, or compound, is formed into a gum strip. As known to those skilled in the art, a gum strip is produced by a press or passing a rubber compound through a mill, calender, multi-head extruder or other suitable means. Preferably, the gum strip is produced by a calender because greater uniformity is believed to be provided. The uncured gum strip is then constructed as an inner surface (exposed inside surface) of an uncured rubber tire structure, also known as the carcass. The innerliner is then sulfur co-cured with the tire carcass during the tire curing operation under conditions of heat and pressure.

Vulcanization of the tire of the present invention is generally carried out, for example, at temperatures of between about 100° C. and 200° C. Preferably, the vulcanization is conducted at temperatures ranging from about 110° C. to 180° C. Any of the usual vulcanization processes may be used such as heating in a press or mold, heating with superheated steam or hot salt or in a salt bath. Preferably, the heating is accomplished in a press or mold in a method known to those skilled in the art of tire curing.

As a result of this vulcanization, the innerliner becomes an integral part of the tire by being co-cured therewith.

Therefore, in practice, the innerliner may, for example, be first constructed as an inner surface of an uncured rubber tire as an uncured compounded rubber gum strip and is then co-cured with the tire during a tire curing operation wherein the said rubber gum strip may have, for example, a thickness in the range of about 0.04 to about 1, alternately in a range of from about 0.05 to about 0.5, centimeters, depending somewhat the type, size and intended use of the tire.

The pneumatic tire with the integral innerliner may be constructed in the form of a passenger tire, truck tire, or other type of bias or radial pneumatic tire.

The following examples are presented in order to illustrate but not limit the present invention. The parts and percentages are by weight unless otherwise noted

### Example 1

In this example, measurement of the particle size distribution of a slate powder is illustrated. A slate powder obtained from Theis & Boerger (Hunsruek, Germany) was analyzed for particle size distribution using vibrating screen sieves. A 100 g sample of the slate powder was passed through a series of five stacked screen sieves using a Retsch Vibrotronic analyzer set at “oscillation 40” and “interval.” The amount retained on each screen was weighed after 60 minutes vibration time, with results shown in Table 1 for two repetitions, runs 1 and 2.

TABLE 1

| sieve size | | amount retained | | average weight % | |
|---|---|---|---|---|---|
| mesh | microns | run 1, g | run 2, g | individual | cumulative |
| 12 | 1700 | 5.4 | 6.6 | 6 | 100 |
| 20 | 850 | 7.1 | 8.1 | 8 | 94 |
| 50 | 300 | 17.5 | 16.9 | 17 | 86 |
| 100 | 150 | 27.2 | 25.3 | 26 | 69 |
| 200 | 75 | 18.7 | 20.3 | 20 | 43 |
| thru 200 | <75 | 24.1 | 22.8 | 23 | 23 |
| total | | 100 | 100 | 100 | |

As seen in Table 1, the slate powder showed a particle size distribution with at least 94 percent less than 1700 microns, at least 86 percent less than 850 microns, at least 69 percent less than 300 microns, at least 43 percent less than 150 microns, and at least 23 percent less than 75 microns. It is to be appreciated that the experimental weight percentages represent the amount passed through the given sieve at the end of the experiment time of sixty minutes; the measured amounts therefore represent a somewhat low estimate of the actual percentages and the amounts are expressed as at least the amount measured.

### Example 2

In this example, the effect of dispersing the slate powder of Example 1 in a bromobutyl rubber innerliner composition is illustrated. All amounts are in parts by weight. The rubber compositions were mixed using a two phase mixing procedure, with addition of the elastomers and fillers in a first, non-productive mix step, followed by addition of conventional amounts of curatives in a second, productive mix step, to obtain a rubber compound.

The mixed compound was formed into test specimens and cured at 170° C. for 25 minutes. Cured samples were then tested for air permeability. Air permeabilities are shown in Table 2 for various filler volumes.

Adhesion test samples were prepared by a standard peel adhesion test on 1″ wide specimens. Strip adhesion samples were made by preparation of a sandwich of two layers of the compound separated by a mylar window sheet. The sandwich was cured and 1″ samples cut centered on each window in the mylar. The cured samples were then tested for adhesion between the sheets in the area defined by the mylar window by 180 degree pull on a test apparatus. Cured samples were then tested for adhesion at the indicated test conditions. Results of the adhesion tests are shown in Table 2 for various filler volumes.

TABLE 2

| Sample No. | | | | | |
|---|---|---|---|---|---|
| 1 | 2 | 3 | 4 | 5 | 6 |

Volume % Filler

| | | | | | | |
|---|---|---|---|---|---|---|
| Carbon Black, phr | 56 | 44 | 28 | 56 | 56 | 56 |
| Slate Powder, phr | 0 | 12 | 28 | 10 | 20 | 5 |

Tensile Properties Cure: 25 min @ 170° C.; Test: @ 23° C.

| | | | | | | |
|---|---|---|---|---|---|---|
| Elongation, % | 1001 | 804 | 764 | 705 | 669 | 751 |
| Mod 100%, MPa | 0.7 | 0.9 | 0.9 | 1.1 | 1.1 | 1.1 |
| Mod 300%, MPa | 1.9 | 2.1 | 1.8 | 3 | 2.9 | 2.9 |
| Tensile Strength, MPa | 7.4 | 6 | 5 | 6.3 | 5.8 | 6.6 |
| Shore A | 44.4 | 49.3 | 47.7 | 54.1 | 55.7 | 54 |
| Rebound | 11.3 | 11.3 | 11.6 | 11.1 | 11 | 11.1 |

Tear Strength Cure: 25 min @ 170° C.; Test: @ 100° C.

| | | | | | | |
|---|---|---|---|---|---|---|
| Tear Strength, N | 16 | 15.3 | 13.2 | 15.1 | 13.5 | 15.6 |

Air Diffusion Cure: 25 min @ 170° C.; Test: @ 90° C.,
Gas = Air @ 6 MPa

| | | | | | | |
|---|---|---|---|---|---|---|
| Diffusion, cm³/min × 10⁸ | 8.27 | 4.48 | 6.00 | 9.51 | 5.34 | 6.61 |

As seen in Table 2, the combination of the slate powder and carbon black shows significantly improved permeability resistance and comparable tear resistance compared to carbon black alone, for constant filler weight. Such behavior is unexpected and surprising, suggesting a synergistic effect of the combination of the carbon black and slate powder.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic tire comprising a carcass and an innerliner radially inward of and in direct contact with the carcass, the innerliner comprising a rubber composition comprising:
100 parts by weight of at least one elastomer; and
from 10 to 80 parts by weight, per 100 parts by weight of elastomer (phr) of carbon black; and
from 1 to 30 phr of slate powder.

2. The pneumatic tire of claim 1, wherein the elastomer is selected from the group consisting of butyl rubber, chlorinated butyl rubber, brominated butyl rubber, synthetic polyisoprene, natural rubber, styrene butadiene rubber, polybutadiene, copolymer of isobutylene and paramethylstyrene, and brominated copolymer of isobutylene and paramethylstyrene.

3. The pneumatic tire of claim 1, wherein the elastomer is selected from the group consisting of butyl rubber, chlorinated butyl rubber, brominated butyl rubber, copolymer of isobutylene and paramethylstyrene, and brominated copolymer of isobutylene and paramethylstyrene.

4. The pneumatic tire of claim 1, wherein the slate powder comprises at least 20 percent by weight of particles of a size less than 75 microns.

5. The pneumatic tire of claim 1, wherein the slate powder comprises at least 23 percent by weight of particles of a size less than 75 microns.

6. The pneumatic tire of claim 1, wherein the slate powder comprises at least 40 percent by weight of particles of a size less than 150 microns.

7. The pneumatic tire of claim 1, wherein the slate powder comprises at least 43 percent by weight of particles of a size less than 150 microns.

8. The pneumatic tire of claim 1, wherein the slate powder comprises at least 60 percent by weight of particles of a size less than 300 microns.

9. The pneumatic tire of claim 1, wherein the slate powder comprises at least 69 percent by weight of particles of a size less than 300 microns.

10. The pneumatic tire of claim 1, wherein the slate powder comprises at least 80 percent by weight of particles of a size less than 850 microns.

11. The pneumatic tire of claim 1, wherein the slate powder comprises at least 86 percent by weight of particles of a size less than 850 microns.

12. The pneumatic tire of claim 1, wherein the slate powder comprises at least 90 percent by weight of particles of a size less than 1700 microns.

13. The pneumatic tire of claim 1, wherein the slate powder comprises at least 94 percent by weight of particles of a size less than 1700 microns.

14. The pneumatic tire of claim 1, wherein the amount of slate powder ranges from 5 to 20 phr.

15. The pneumatic tire of claim 1, wherein the amount of carbon black ranges from 20 to 60 phr.
